(19) United States
(12) Patent Application Publication
(10) Pub. No.: US 2017/0059939 A1
(43) Pub. Date: Mar. 2, 2017

(54) DISPLAY DEVICE

(71) Applicant: Samsung Display Co., Ltd., Yongin-si (KR)

(72) Inventors: Jaejoong KWON, Suwon-si (KR); Hyosun KIM, Seongnam-si (KR)

(21) Appl. No.: 15/071,833

(22) Filed: Mar. 16, 2016

(30) Foreign Application Priority Data
Aug. 26, 2015 (KR) 10-2015-0120420

(51) Int. Cl. G02F 1/1335; F21V 8/00

(52) U.S. Cl. CPC G02F 1/133615; G02B 6/0025; G02B 6/0053; G02B 6/0055; G02F 1/133514; G02F 2001/133624

(57) ABSTRACT

Provided is a display device including a display panel, a first backlight unit, and a second backlight unit. The first backlight unit provides first light beams to the display panel. The second backlight unit is disposed between the display panel and the first backlight unit, and provides second light beams which have a different wavelength from that of the first light beams to the display panel. The second backlight unit includes a front light guide plate and a short-wavelength light source. The short-wavelength light source emits light which has a wavelength of about 340 nm to about 430 nm to the top surface of the front light guide plate.

### RELATED APPLICATION

This application claims priority to Korean Patent Application No. 10-2015-0120420, filed on Aug. 26, 2015, and all the benefits accruing therefrom under 35 U.S.C. §119, the content of which in its entirety is incorporated by reference.

### BACKGROUND

1. Field

The present disclosure herein relates to a display device which includes a backlight unit.

2. Discussion of the Related Technology

In a non-light emitting type display device such as a liquid crystal display device, a display panel which displays images is incapable of self-emission, and is thus equipped with a backlight unit for providing light to the display panel.

The backlight unit may include a light source, a light guide plate which guides the light emitted from the light source toward the display panel, and an optical member which controls the path of the light emitted from the light guide plate.

Typically, the display panel uses three primary colors which consist of red, green, and blue to display colors. Such red, green, and blue respectively correspond to the spectral sensitivity curves of three types of cone cells in the human eye.

### SUMMARY

The present disclosure provides a display device which humans and animals other than humans can view together.

One aspect of the inventive concept provides a display device, which may comprise: a display panel; a first backlight unit configured to provide first light beams toward the display panel, the first light beams having wavelengths in a first wavelength range; and a second backlight unit disposed between the display panel and the first backlight unit, and configured to provide second light beams toward the display panel, the second light beams having wavelengths in a second wavelength range different from the first wavelength range, wherein the second backlight unit comprises: a front light guide plate comprising a front surface, a rear surface, a top surface, a bottom surface, a left surface and a right surface; and a short-wavelength light source configured to emit light which has a wavelength of about 340 nm to about 430 nm toward the top surface of the front light guide plate. The second wavelength range may comprise a range of about 340 nm to about 430 nm.

In the foregoing device, the second backlight unit may further comprise a front diffuser which is disposed between the front light guide plate and the display panel and configured to diffuse the light which is guided by the front light guide plate such that the second backlight unit provides the second light beams toward the display panel. The first light beams may be configured to travel in a first traveling direction which is generally perpendicular to the display surface, and the second beams are configured to travel in a second traveling direction which is different from the first traveling direction. When the display device is placed over a floor such that a display surface of the display panel is generally perpendicular to the floor, the second light beams may be configured to travel in the second traveling direction toward the floor. The first traveling direction of the first light beams and the second traveling direction of the second light beams may form a predetermined acute angle therebetween.

Still in the foregoing device, the first backlight unit may comprise: a long-wavelength light source configured to emit light which has a wavelength of about 430 nm to about 780 nm; a rear light guide plate configured to guide the light, which is emitted from the long-wavelength light source, toward the display panel; a rear diffuser configured to diffuse the light which is guided by the rear light guide plate; and a prism sheet configured to adjust traveling directions of the diffused light such that the first backlight unit provides the first light beams traveling in a direction generally perpendicular to a display surface of the display panel. The prism sheet may comprise: a vertical prism sheet configured to adjust the traveling direction of the diffused light in a vertical plane; and a horizontal prism sheet configured to adjust the traveling direction of the diffused light in a horizontal plane, wherein the vertical prism is located between the rear diffuser and the horizontal prism sheet. The prism sheet may comprise: a horizontal prism sheet configured to adjust the traveling direction of the diffused light in a horizontal plane; and a vertical prism sheet configured to adjust the traveling direction of the diffused light in a vertical plane, wherein the horizontal prism is located between the rear diffuser and the vertical prism sheet.

Further in the foregoing device, the first backlight unit may comprise: a long-wavelength light source configured to emit light which has a wavelength of about 430 nm to about 780 nm; and a reflective layer configured to reflect the light, which is emitted from the long-wavelength light source, toward the display panel. The display panel may comprise: a first color filter capable of transmitting light which has a wavelength of about 600 nm to about 750 nm; a second color filter capable of transmitting light which has a wavelength of about 495 nm to about 600 nm; and a third color filter capable of transmitting light which has a wavelength of about 340 nm to about 495 nm. The display panel may comprise: a first color filter capable of transmitting light which has a wavelength of about 600 nm to about 750 nm; a second color filter capable of transmitting light which has a wavelength of about 495 nm to about 600 nm; a third color filter capable of transmitting light which has a wavelength of about 430 nm to about 495 nm; and a fourth color filter capable of transmitting light which has a wavelength of about 340 nm to about 430 nm. The display panel receives first data signals and second data signals, the second data signals alternate with the first data signals; the first backlight unit is turned on or off in synchronization with the first data signals; and the second backlight unit is turned on or off in synchronization with the second data signals.

Another aspect of the inventive concept provides a display device which may comprise: a display panel comprising a display surface and configured to display an image on the display surface, wherein the display panel is configured to be placed over a floor such that the display surface is generally perpendicular to the floor; a first backlight unit configured to provide first light beams, which travel through the display panel in a first direction generally perpendicular to the display surface; and a second backlight unit disposed between the display panel and the first backlight unit, and configured to provide second light beams, which travel toward the floor through the display panel in a second direction which forms a predetermined acute angle with respect to the first direction, wherein at least part of the second light beams have a wavelength of about 340 nm to about 430 nm.

In the foregoing device, the first light beams may have a wavelength of about 380 nm to about 780 nm. The first backlight unit may comprise: a first light source; a first light guide plate configured to guide light, which is emitted from the first light source, toward the display panel; a first diffuser configured to diffuse light which is guided by the first light guide plate; and a prism sheet configured to adjust traveling directions of the diffused light such that the first backlight unit provides the first light beams traveling in a direction generally perpendicular to a display surface of the display panel. The first backlight unit may comprise: a first light source configured to emit light; and a reflective layer configured to reflect the light, which is emitted from the first light source, toward the display panel. The second backlight unit may comprise: a second light guide plate configured to guide incident light toward the display panel; a second light source configured to emit light having a wavelength of at least about 340 nm to about 430 nm to the second light guide plate, and is disposed over a top surface of the second light guide plate; and a second diffuser configured to diffuse the light which is guided by the second light guide plate.

Still in the foregoing device, the display panel may comprise: a first color filter capable of transmitting light which has a wavelength of about 600 nm to about 750 nm; a second color filter capable of transmitting light which has a wavelength of about 495 nm to about 600 nm; and a third color filter capable of transmitting light which has a wavelength of about 340 nm to about 495 nm. The display panel may comprise: a first color filter capable of transmitting light which has a wavelength of about 600 nm to about 750 nm; a second color filter capable of transmitting light which has a wavelength of about 495 nm to about 600 nm; a third color filter capable of transmitting light which has a wavelength of about 430 nm to about 495 nm; and a fourth color filter capable of transmitting light which has a wavelength of about 340 nm to about 430 nm. The display panel receives first data signals and second data signals, the second data signals alternate with the first data signals; the first backlight unit is turned on or off in synchronization with the first data signals; and the second backlight unit is turned on or off in synchronization with the second data signals.

An embodiment of the inventive concept provides a display device including a display panel; a first backlight unit which provides a first light to the display panel; and a second backlight unit which is disposed between the display panel and the first backlight unit, and which provides a second light which has a different wavelength than the first light to the display panel.

In an embodiment, the second backlight unit may include a front light guide plate which comprises a front surface, a rear surface, a top surface, a bottom surface, a left surface, and a right surface; and a short-wavelength light source which provides light which has a wavelength of at least about 340 nm to about 430 nm to the top surface of the front light guide plate.

In an embodiment, the first backlight unit may further include a front diffuser which diffuses the light which is guided by the front light guide plate.

In an embodiment, the second light may be oriented in a direction toward the floor. The first light may be oriented in a direction which is parallel to the floor. The direction in which the first light is oriented and the direction in which the second light is oriented may form a predetermined acute angle.

In an embodiment, the first backlight unit may include a long-wavelength light source which provides light which has a wavelength of about 430 nm to about 780 nm; a rear light guide plate which guides light, which is emitted from the long-wavelength light source, toward the display panel; a rear diffuser which diffuses light which is guided by the rear light guide plate; and a prism sheet which orients the light, which is diffused by the rear diffuser, in a direction which is parallel to the floor.

In an embodiment, the prism sheet may include a vertical prism sheet which regulates the orientation direction of light, which is diffused by the rear diffuser, up or down; and a horizontal prism sheet which regulates the orientation direction of light, which is regulated by the vertical prism sheet, left or right.

In an embodiment, the first backlight unit may include a long-wavelength light source which provides light which has a wavelength of about 430 nm to about 780 nm; and a reflective layer which reflects light, which is provided from the long-wavelength light source, toward the display panel.

In an embodiment, the display panel may include a first color filter capable of transmitting light which has a wavelength of about 600 nm to about 750 nm; a second color filter capable of transmitting light which has a wavelength of about 495 nm to about 600 nm; and a third color filter capable of transmitting light which has a wavelength of about 340 nm to about 495 nm.

In an embodiment, the display panel may include a first color filter capable of transmitting light which has a wavelength of about 600 nm to about 750 nm; a second color filter capable of transmitting light which has a wavelength of about 495 nm to about 600 nm; a third color filter capable of transmitting light which has a wavelength of about 430 nm to about 495 nm; and a fourth color filter capable of transmitting light which has a wavelength of about 340 nm to about 430 nm.

In an embodiment, the display panel receives first data signals and second data signals, the second data signals alternate with the first data signals; the first backlight unit is turned on or off in synchronization with the first data signals; and the second backlight unit is turned on or off in synchronization with the second data signals.

In an embodiment, the display device installed perpendicular to the floor includes a display panel which displays image data, and comprises a display surface that is defined to be perpendicular to the floor; a first backlight unit which provides a first light, which is orientated in a perpendicular direction to the display surface, to the display panel; and a second backlight unit which is disposed between the display panel and the first backlight unit, and which provides a second light, which forms a predetermined acute angle with the first light and is oriented in a direction toward the floor, to the display panel, wherein the second light includes light which has a wavelength of at least about 340 nm to about 430 nm.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIGS. 1 and 2 illustrate a human and an animal other than the human using a display device together;

FIG. 3A illustrates the sensitivity to light of cone cells in a human;

FIG. 3B illustrates the sensitivity to light of cone cells in a dog;

FIG. 4 illustrates the luminous efficacy of humans and dogs according to wavelength bands of light;

FIG. 5 illustrates a side view of a display device according to an embodiment of the inventive concept;

FIG. 6 is an exploded perspective view of a display device according to an embodiment of the inventive concept;

FIG. 7A illustrates a first light source according to an embodiment of the inventive concept;

FIG. 7B illustrates a second light source according to an embodiment of the inventive concept;

FIG. 8A illustrates a viewing angle graph of a first backlight unit according to an embodiment of the inventive concept;

FIG. 8B illustrates a viewing angle graph of a second backlight unit according to an embodiment of the inventive concept;

FIG. 9A illustrates a cross-section of a side of a display device according to an embodiment of the inventive concept;

FIG. 9B illustrates the spectrum of light which is transmitted by color filters of a display panel according to an embodiment of the inventive concept;

FIG. 10A illustrates a cross-section of a side of a display device according to an embodiment of the inventive concept;

FIG. 10B illustrates the spectrum of light which is transmitted by color filters of a display panel according to an embodiment of the inventive concept;

FIG. 11 is an exploded perspective view of a display device according to an embodiment of the inventive concept; and

FIG. 12 illustrates the drive timing of a first backlight unit and a second backlight unit according to an embodiment of the inventive concept.

### DETAILED DESCRIPTION

Features and advantages of the inventive concept will be more easily understood through the accompanying drawings and embodiments. However, the inventive concept should not be construed as limited to the embodiments set forth herein and may be embodied in different forms. Rather, these embodiments are provided so that this disclosure will be thorough and complete, and will fully convey the scope of the inventive concept to those skilled in the art.

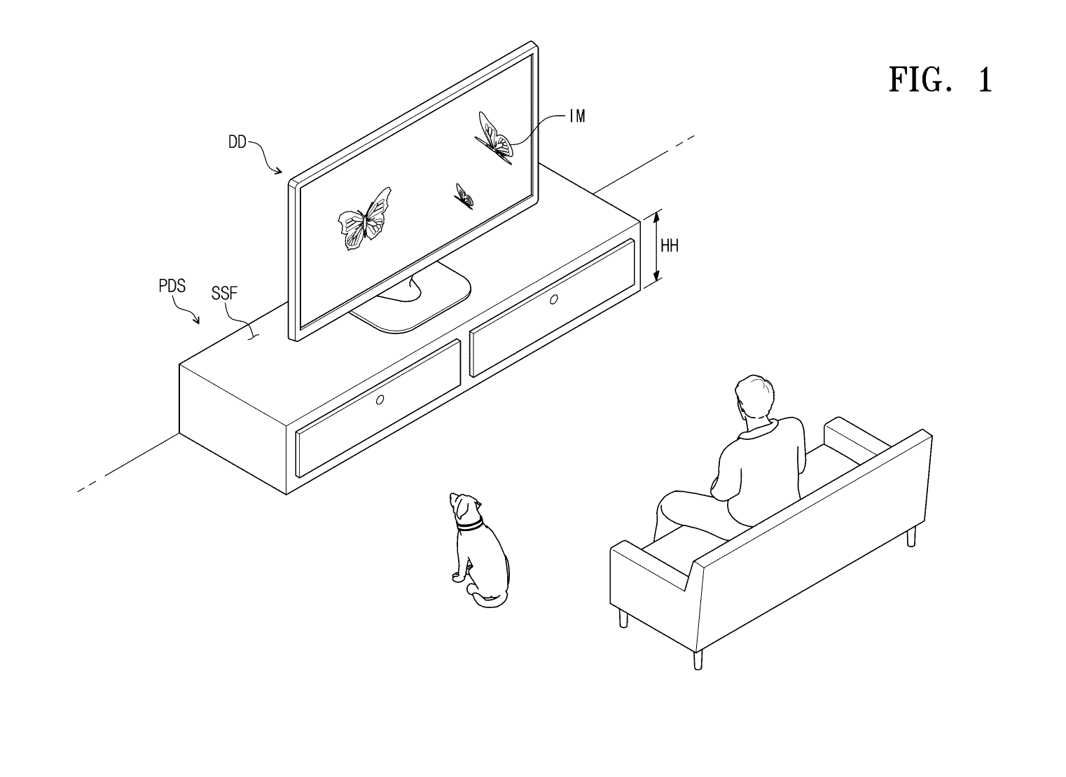

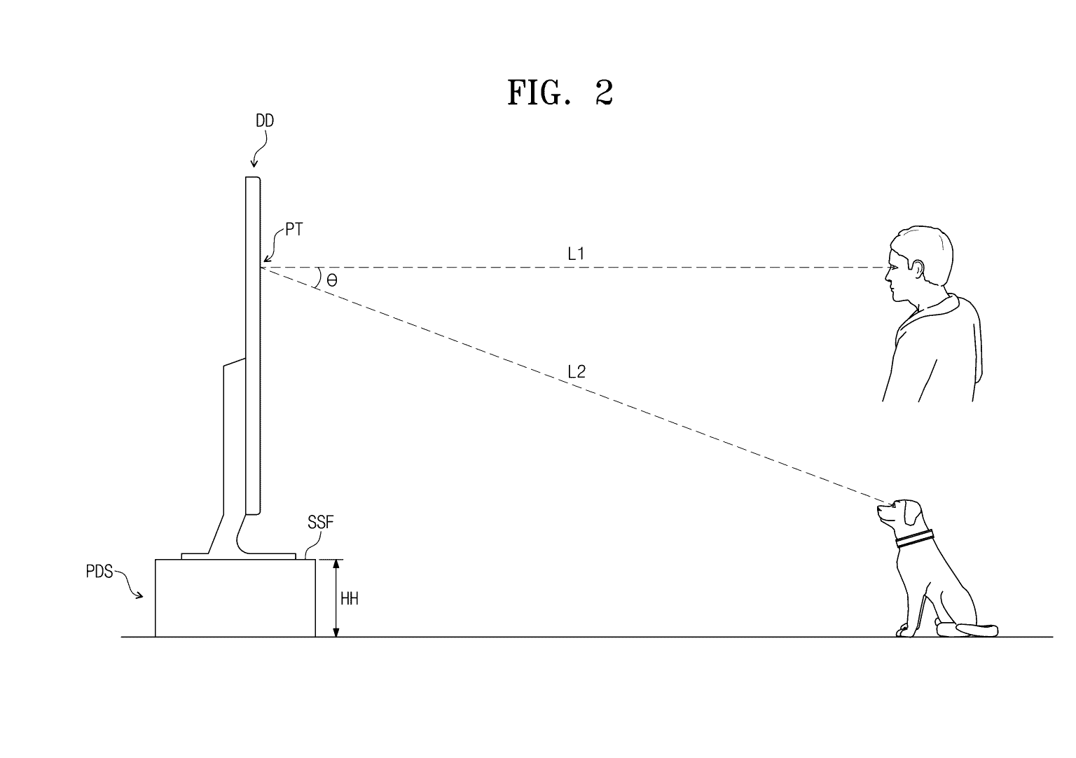

FIGS. 1 and 2 illustrate a human and an animal other than the human using a display device together. A dog is shown as an example of the animal which is other than the human.

Recently, more humans are raising pets in the house, and the vast majority of such pets are dogs. If a dog is raised in the house, when the human is watching TV, many times the dog also watches TV together with the human.

Referring to FIG. 1, a display device DD is disposed on a supporting surface SSF and provides image data IM to a viewer. The supporting surface SSF may be provided by a stand PDS which has a predetermined height HH.

When the human is viewing the image data IM which is coming out from the display device DD, viewing is usually done while sitting on a sofa or a chair. However, the dog usually views the image data IM, which is coming out from the display device DD, from the floor which is below the sofa or chair.

FIG. 2 illustrates a first light beam L1 which is emitted from a point PT in the display device DD and arrives at the human who is sitting in the sofa or chair, and a second light beam L2 which is emitted from the point PT in the display device DD and arrives at the dog which is sitting on the floor.

Due to the height difference between the eye position of the human and the eye position of the dog, the first light beam L1 and the second light beam L2 form a predetermined acute angle θ.

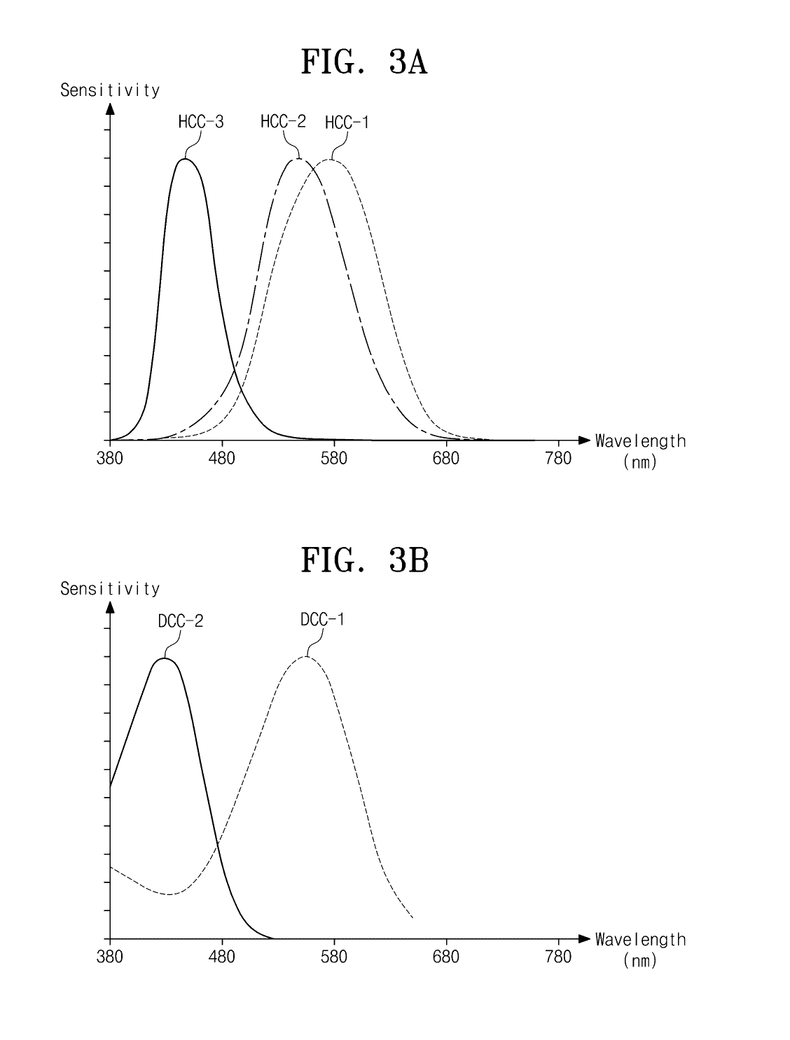

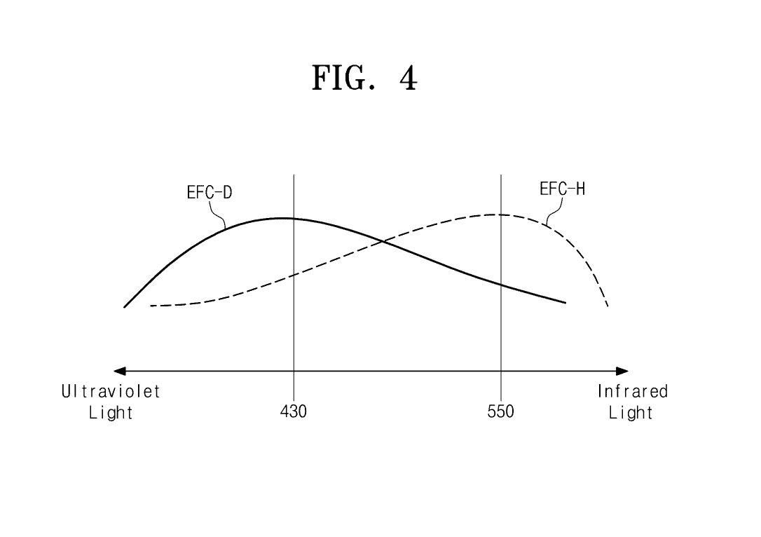

FIG. 3A illustrates the sensitivity to light of cone cells in humans. FIG. 3B illustrates the sensitivity to light of cone cells in dogs.

Typically, display devices display images by using the three primary colors. The three primary colors consist of red, green, and blue, and are determined based on the trichromatic visual characteristic of humans. Humans sense blue, red, and green through first human cone cells (L cone cells), second human cone cells (M cone cells), and third human cone cells (S cone cells), respectively, which are formed in the eyes of humans.

FIG. 3A illustrates a first human cone cell sensitivity curve HCC-1, a second human cone cell sensitivity curve HCC-2, and a third human cone cell sensitivity curve HCC-3.

The first human cone cell sensitivity curve HCC-1 is a functional representation of the sensitivity to light of the first human cone cells, and the peak wavelength thereof is about 564 nm. Thus, the first human cone cells are sensitive to yellow to green light, which among visible light has a relatively long-wavelength, and are most sensitive to light which has a wavelength of about 564 nm.

The second human cone cell sensitivity curve HCC-2 is a functional representation of the sensitivity to light of the second human cone cells, and the peak wavelength thereof is about 420 nm. Thus, the second human cone cells are sensitive to medium-wavelength cyan to blue light, and are most sensitive to light which has a wavelength of about 534 nm.

The third human cone cell sensitivity curve HCC-3 is a functional representation of the sensitivity to light of the third human cone cells, and the peak wavelength thereof is about 420 nm. Thus, the third human cone cells are sensitive to short-wavelength blue to violet light, and are most sensitive to light which has a wavelength of about 420 nm.

Since the three primary colors described above are those based on humans, the three primary colors for humans cannot be directly applied to animals other than humans.

Primary colors for dogs may be determined based on visual characteristics of dogs. More specifically, the primary colors for dogs may be respectively sensed by first dog cone cells and second dog cone cells which are formed in the eyes of dogs.

FIG. 3B illustrates a first dog cone cell sensitivity curve DCC-1 and a second dog cone cell sensitivity curve DCC-2.

As illustrated in FIG. 3B, the first dog cone cell sensitivity curve DCC-1 is a functional representation of the sensitivity to light of the first dog cone cells, and the peak wavelength thereof is about 555 nm. Thus, the first dog cone cells are most sensitive to light which has the wavelength of about 555 nm.

The second dog cone cell sensitivity curve DCC-2 is a functional representation of the sensitivity to light of the second dog cone cells, and the peak wavelength thereof is about 410 nm. Thus, the second dog cone cells are most sensitive to light which has the wavelength of about 410 nm.

As illustrated in FIGS. 3A and 3B, the respective first and second dog cone cell sensitivity curves DCC-1 and DCC-2 have differences with the respective first to third human cone cell sensitivity curves HCC-1, HCC-2, and HCC-3. More specifically, the respective peak wavelengths of the first and second dog cone cell sensitivity curves DCC-1 and DCC-2 differ from the respective peak wavelengths of the first to third human cone cell sensitivity curves HCC-1, HCC-2, and HCC-3. Moreover, the full width half maximums of the first and second dog cone cell sensitivity curves DCC-1 and DCC-2 differ from the full width half maximums of the first to third human cone cell sensitivity curves HCC-1, HCC-2, and HCC-3.

Sensitivity decreases for each of the first and second human cone cell sensitivity curves HCC-1 and HCC-2 when going from the peak wavelength toward short wavelengths, and thus the sensitivity approaches 0 for light which has a wavelength of about 420 nm or shorter. On the other hand, sensitivity decreases as the first dog cone cell sensitivity curve DCC-1 goes from the peak wavelength of about 555 nm toward short wavelengths, down to about 440 nm, whereupon the sensitivity increases when going toward short wavelengths. Therethrough, it may be known that unlike the first and second human cone cells, the first dog cone cells are sensitive to not only light which is in the long-wavelength region, but also to light which is in the short-wavelength region.

The third human cone cells HCC-3 have a sensitivity which is near 0 with regard to light which has a wavelength that is shorter than about 380 nm. Thus, humans are nearly incapable of sensing light which has a wavelength that is shorter than about 380 nm. On the other hand, the first and second dog cone cell sensitivity curves DCC-1 and DCC-2 have a high sensitivity to light which has a wavelength that is shorter than about 380 nm. Thus, dogs, unlike humans, are well capable of sensing light which has a wavelength that is shorter than about 380 nm, in embodiments, light which is in the ultraviolet region.

FIG. 4 illustrates the luminous efficacy of humans and dogs according to wavelength bands. A human luminous efficacy curve EFC-H, as a functional representation of the sensitivity to light of humans, is determined by combination of the sensitivities to light of the first to third human cone cells. A dog luminous efficacy curve EFC-D, as a functional representation of the sensitivity to light of dogs, is determined by combination of the sensitivities to light of the first and second dog cone cells.

As described with reference to FIGS. 3A and 3B, humans do not have cone cells which react to light which has a wavelength that is shorter than about 380 nm. On the other hand, humans have the first and second human cone cells which are highly sensitive to light which has a wavelength of about 530 nm to about 570 nm. Thus, the peak wavelength of the human luminous efficacy curve EFC-H is the relatively long-wavelength of about 550 nm.

Among the first dog cone cells and second dog cone cells of dogs, only the first dog cone cells are highly sensitive to light which has a wavelength of about 530 nm to about 570 nm. On the other hand, both the first dog cone cells and second dog cone cells react sensitively to light which has a wavelength that is shorter than about 430 nm. Thus, the peak wavelength of the dog luminous efficacy curve EFC-D is the relatively short wavelength of about 430 nm, and dogs have a relatively high sensitivity, even to light in the ultraviolet region which has a wavelength that is shorter than about 380 nm.

As such, since the dog luminous efficacy curve EFC-D differs from the human luminous efficacy curve EFC-H, when dogs sense the image which is emitted from the display device that is made for humans, the dogs are unable to recognize the images as having the same colors as actual objects. However, when light in the short-wavelength region and ultraviolet region, which may be easily recognized by dogs, is additionally emitted in a direction in which dogs sense the image being emitted from the display device, both humans and dogs may recognize colors which are identical to those of actual objects, through the display device.

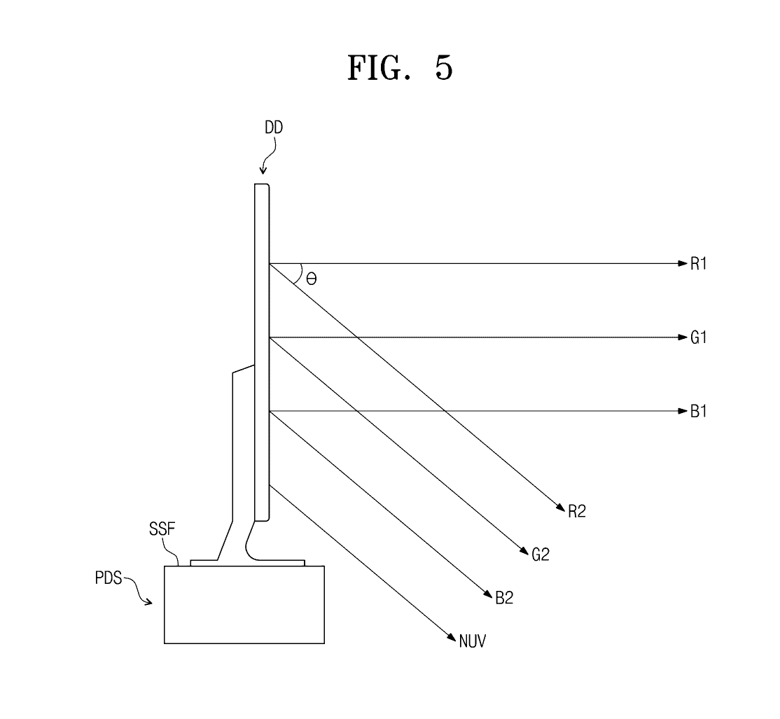

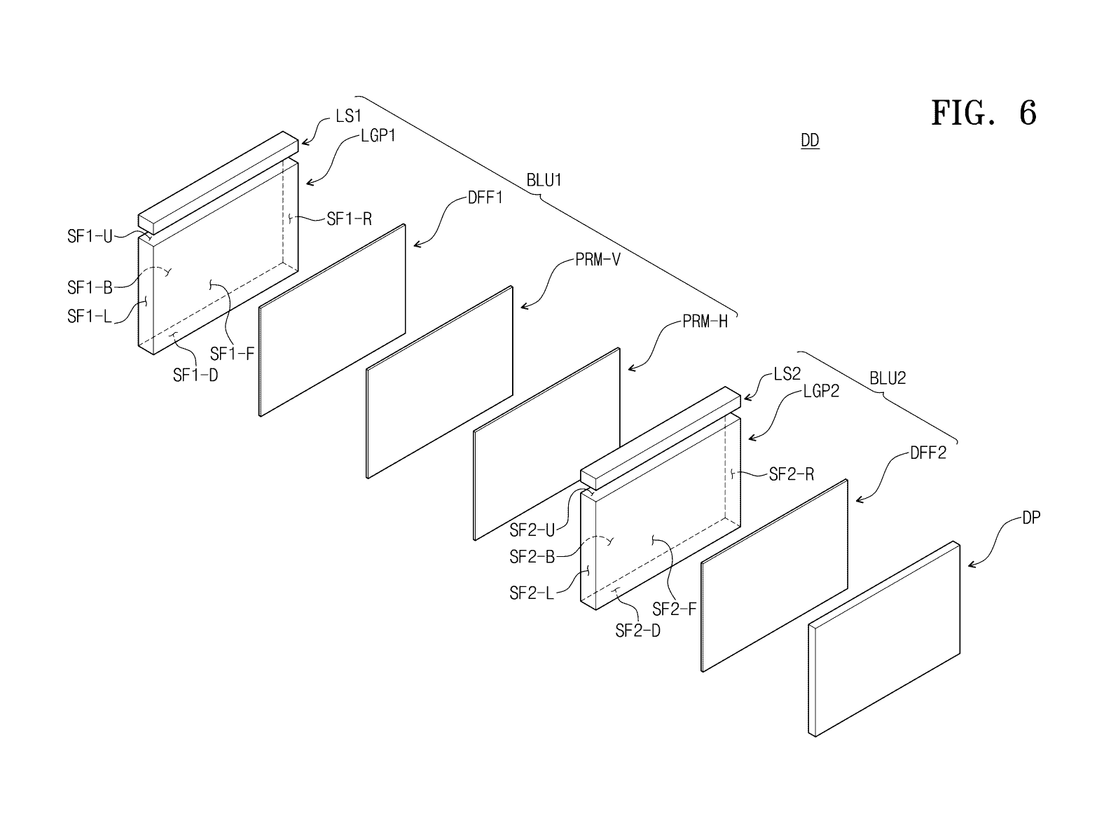

FIG. 5 illustrates a side view of the display device according to an embodiment of the inventive concept. Referring to FIG. 5, in embodiments, first red light beams R1 and second red light beams R2 may be emitted from a single red pixel. First green light beams G1 and second green light beams G2 may be emitted from a single green pixel. First blue light beams B1 and second blue light beams B2 may be emitted from a single blue pixel.

The first red light beams R1, the first green light beams G1, and the first blue light beams B1 are mostly emitted toward humans who are positioned in front of the display device DD. The second red light beams R2, the second green light beams G2, and the second blue light beams B2 are mostly emitted toward dogs which are in a lower position than the display device DD.

The first red light beams R1, the first green light beams G1, and the first blue light beams B1 form the predetermined acute angle θ with respect to the second red light beams R2, the second green light beams G2, and the second blue light beams B2, respectively. The predetermined acute angle θ may be determined by the positions of the human and dog.

The display device DD emits near-ultraviolet light beams NUV which are emitted in line with the second red light beams R2, the second green light beams G2, and the second blue light beams B2. The wavelength of the near-ultraviolet light beams NUV may be about 340 nm to about 430 nm. Since light which has a wavelength of about 340 nm to about 430 nm is short-wavelength light which may be easily recognized by dogs, the dogs may recognize all of the colors which are identical to those of actual objects, through the display device DD.

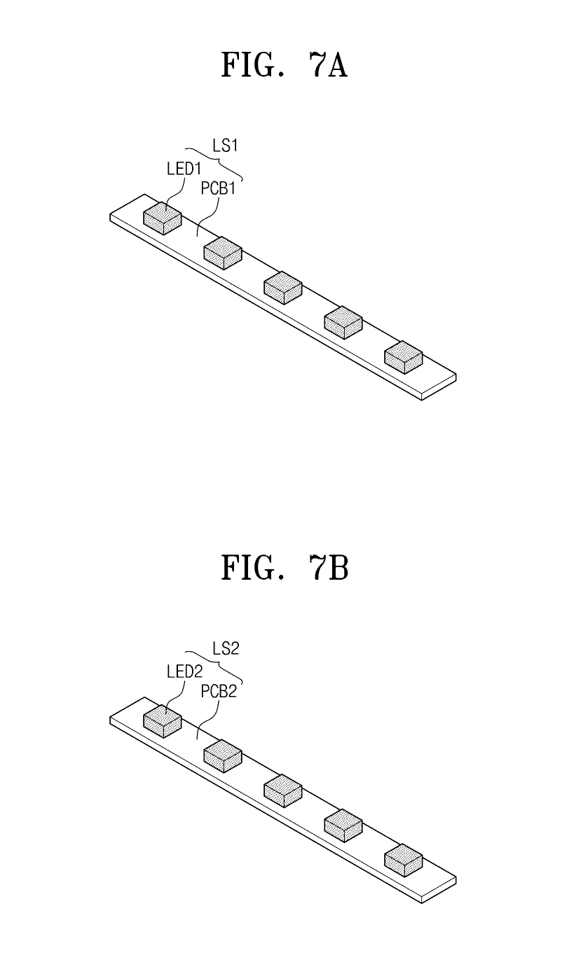

FIG. 6 is an exploded perspective view of the display device according to an embodiment of the inventive concept. FIG. 7A illustrates a first light source according to an embodiment of the inventive concept. FIG. 7B illustrates a second light source according to an embodiment of the inventive concept.

The display device DD includes a first backlight unit BLU1, a second backlight unit BLU2, and a display panel DP. In embodiments, the first backlight unit BLU1 may provide back light for generating the first red light beams, the first green light beams and the first blue light beams, while the second backlight unit may provide back light for generating the second red light beams, the second green light beams, the second blue light beams and the near-ultraviolet light beams.

The first backlight unit BLU1 includes a first light guide plate (or rear light guide plate) LGP1, the first light source (or long-wavelength light source) LS1, a reflective member, a first diffuser (or rear diffuser) DFF1, and prism sheets PRM-V and PRM-H.

The first light guide plate LGP1 guides light, which is emitted from the first light source LS1, generally toward the display panel DP. The first light guide plate LGP1 may include a first front surface SF1-F, a first rear surface SF1-B, a first top surface SF1-U, a first bottom surface SF1-D, a first left surface SF1-L, and a first right surface SF1-R. The first front surface SF1-F is the surface which emits light generally toward the display panel DP. A scattering pattern which scatters light may be formed on at least one surface among the first front surface SF1-F and the first rear surface SF1-B.

Referring to FIG. 7A, the first light source LS1 may include a plurality of first light emitting diode packages LED1 and a first printed circuit board PCB1. The first light emitting diode packages LED1 are mounted on the first printed circuit board PCB1. Referring to FIG. 6, the first light source LS1 is disposed over the first top surface SF1-U of the first light guide plate LGP1, but embodiments of the inventive concept are not limited thereto. The first light source LS1 emits light in the visible light region which has a wavelength of about 430 nm to about 780 nm. In the illustrated embodiment, light emitted from the first light source LS1 is incident on the first light guide plate LGP1.

The reflective member is disposed adjacent to the first rear surface SF1-B of the first light guide plate LGP1. The reflective member reflects light which passed through the first rear surface SF1-B of the first light guide plate LGP1. The light which is reflected by the reflective member may again be incident on the first light guide plate LGP1.

In an embodiment of the inventive concept, the reflective member may be in the form of a sheet which has a thickness of several micrometers to several hundreds of micrometers. In another embodiment, the reflective member may be in the form of a coating on a bottom surface of the first light guide plate LGP1.

The first diffuser DFF1 diffuses light which is guided by and transmitted from the first light guide plate LGP1. The first diffuser DFF1 may include a transparent binder and a spherical bead. The binder may be made of one of acrylic resin, polyurethane, polyester, fluorine-based resin, silicon-based resin, polyamide, or epoxy resin. The bead may be made of at least one of acrylic resin, polyurethane, polyvinyl chloride, polystyrene, polyacrylonitrile, or polyamide.

Since the binder and bead allow light to pass through, those which are colorless and transparent are desirable. In embodiments, an average particle diameter of the bead is about 1 μm and about 50 μm. When the average particle diameter is in the above range, a satisfactory light diffusion function may be exhibited, and application of the resin composition which makes up the first diffuser DFF1 may be facilitated. The prism sheets PRM-V and PRM-H are disposed between the first diffuser DFF1 and the second backlight unit BLU2. The prism sheets PRM-V and PRM-H may include a vertical prism sheet PRM-V and a horizontal prism sheet PRM-H. The prism sheets PRM-V and PRM-H focus light, which is diffused by the first diffuser DFF1, toward the display panel DP. In embodiments, the vertical prism sheet PRM-V is configured to bend or adjust directions of light beams within a vertical plane, while the horizontal prism sheet PRM-H is configured to bend or adjust directions of light beams in a horizontal plane.

In embodiments, the vertical prism sheet PRM-V regulates the direction of incident light, up or down. The horizontal prism sheet PRM-H regulates the direction of incident light, left or right. In FIG. 6, the vertical prism sheet PRM-V is positioned closer to the first diffuser DFF1 than is the horizontal prism sheet PRM-H, but is not limited thereto. The horizontal prism sheet PRM-H may also be positioned closer to the first diffuser DFF1 than is the vertical prism sheet PRM-V.

FIG. 6 illustrates the vertical prism sheet PRM-V and horizontal prism sheet PRM-H as being distinct, but the prism sheets are not limited thereto and only one prism sheet may be disposed.

The second backlight unit BLU2 may include a second light guide plate (or front light guide plate) LGP2, the second light source (or short-wavelength light source) LS2, and a second diffuser (or rear diffuser) DFF2.

The second light guide plate LGP2 guides light, which is emitted from the second light source LS2, generally toward the display panel DP. The second light guide plate LGP2 may include a second front surface SF2-F, a second rear surface SF2-B, a second top surface SF2-U, a second bottom surface SF2-D, a second left surface SF2-L, and a second right surface SF2-R. The second front surface SF2-F is the surface which emits light generally toward the display panel DP. A scattering pattern which scatters light may be formed on at least one of surfaces among the second front surface SF2-F and the second rear surface SF2-B.

Referring to FIG. 7B, the second light source LS2 may include a plurality of second light emitting diode packages LED2 and a second printed circuit board PCB2. The second light emitting diode packages LED2 are mounted on the second printed circuit board PCB2. The second light source LS2 is disposed on the second top surface SF2-U of the second light guide plate LGP2. The light emitted from the second light source includes light beams having wavelengths ranging from about 340 nm to about 430 nm. The wavelength of the light emitted from the second light source LS2 is not limited to about 340 nm to about 430 nm. In embodiments, the light emitted from the second light source may further include light beams with wavelengths greater than about 430 nm. In alternative embodiments, the light emitted from the second light source does not include a light beam with a wavelength smaller than about 340 nm.

The second diffuser DFF2 diffuses light which is guided by and transmitted from the second light guide plate LGP2. Description of the configuration and materials of the second diffuser DFF2 may be identical to description given about the configuration and materials of the first diffuser DFF1, and thus will not be given.

The display panel DP displays images on its display surface. The display panel DP according to the present embodiment is not particularly limited, and may include non-light emitting type, in embodiments, reflective/transmissive type or transmissive type display panels which require a separate light source. Hereinafter, the display panel DP is described as the liquid crystal display panel.

The display panel DP may include a first substrate, a second substrate facing the first substrate, and a liquid crystal layer disposed therebetween. The liquid crystal layer may include a plurality of liquid crystal molecules whose orientation state changes according to the electric field which forms between the first substrate and the second substrate. Although not specifically shown, a pair of polarizing plates may be disposed on the top and bottom of the display panel DP.

In FIG. 6, the display panel DP is illustrated as a flat shape, but is not limited thereto, and may be curved along a directional axis in a concave form. The curved display panel DP may be formed by using the first substrate and second substrate which are made of flexible materials. However, the curved display panel DP is not limited thereto, and may be formed by using the curved first substrate and curved second substrate which are made of rigid materials, such that the display panel DP itself is curved. In embodiments, the display panel is curved in a section taken along a horizontal plane, but is not curved in a section taken along a vertical plane.

Referring back to FIGS. 6, 7A and 7B, in embodiments, the first backlight unit BlU1 transmits first light beams toward the display panel. The first light beams travels in a first direction which is generally perpendicular to the display surface of the display panel. In embodiments, the first direction has a first angle with respect to a plane perpendicular to the display surface, the first angle being smaller than about 15°, about 12°, about 10°, about 8°, about 5°, about 3°, about 2° or about 1°. The wavelengths of the first light beams range from about 380 nm to about 780 nm. In some embodiments, the wavelengths of the first light beams range from about 430 nm to about 750 nm. In one embodiment, the first light beams do not have a wavelength smaller than about 430 nm. In another embodiment, the first light beams do not have a wavelength smaller than about 380 nm.

Still referring to FIGS. 6, 7A and 7B, in embodiments, the second backlight unit BlU2 transmits second light beams toward the display panel. The second light beams travel in a second direction with a second angle with respect to the plane perpendicular to the display surface, the second angle being ranges from about 15° to about 60°. In some embodiments, the second angle may be about 14°, about 17°, about 19°, about 22°, about 25°, about 28°, about 30°, about 33°, about 38°, about 45°, about 50°, about 60° or about 65°. In one embodiment, the second angle may be between two selected among the foregoing angles. The wavelengths of the second light beams range from about 340 nm to about 780 nm. In some embodiments, the wavelengths of the second light beams range from about 340 nm to about 750 nm. In one embodiment, the second light beams do not have a wavelength smaller than about 340 nm. In embodiments, the second light beams may have wavelengths ranging from about 340 nm to about 430 nm, while the first light beams do not have wavelengths smaller than 430 nm.

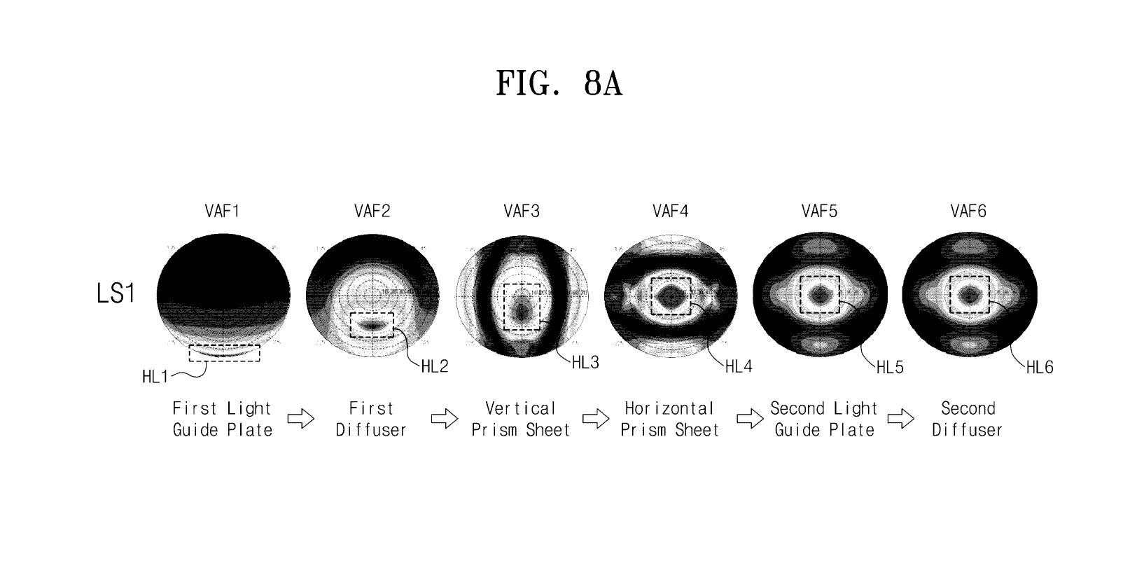

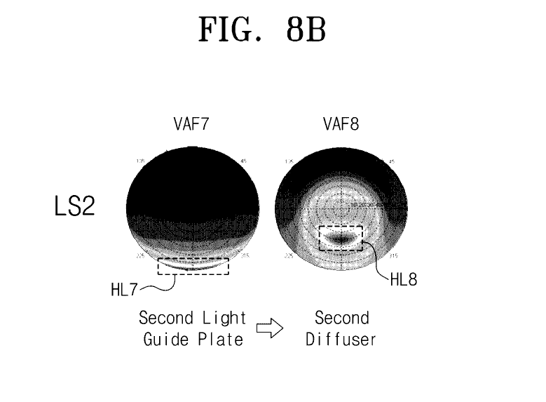

FIG. 8A illustrates a viewing angle graph of the first backlight unit in the display device according to an embodiment of the inventive concept. FIG. 8B illustrates a viewing angle graph of the second backlight unit in the display device according to an embodiment of the inventive concept.

FIG. 8A illustrates a viewing angle graph of light which is emitted from the first backlight unit BLU1, in the case in which only the first light LS1 (refer to FIG. 6) is turned on.

First to sixth viewing angle graphs VAF1 to VAF6 are measurements of the intensity of light which was perpendicularly incident on a hemispheric lens which was placed on each of the first light guide plate LGP1, the first diffuser DFF1, the vertical prism sheet PRM-V, the horizontal prism sheet PRM-H, the second light guide plate LGP2, and the second diffuser DFF2. For measurement thereof, a measuring instrument known as EZ Contrast from ELDIM was used. A larger data value in the viewing angle graph indicates a greater amount of incident light.

In the first viewing angle graph VAF1, a first highlight region HL1, which is the lowest edge region in the graph, has the largest data value. Therethrough, it may be known that light which is emitted from the first light guide plate LGP1 is oriented in a direction toward the floor which is lower than the display device DD. Such is because, as illustrated in FIG. 6, the first light source LS1 is disposed on the first top surface SF1-U of the first light guide plate LGP1.

In the second viewing angle graph VAF2, a second highlight region HL2, which is the lower middle region in the graph, has the largest data value Therethrough, it may be known that light which is transmitted by the first diffuser DFF1 is more diffuse than light which is emitted from the first light guide plate LGP1. Moreover, light which is transmitted by the first diffuser DFF1 is still oriented in a direction toward the floor which is lower than the display device DD.

In the third viewing angle graph VAF3, a third highlight region HL3, which is the central region in the graph, has the largest data value. Since the vertical prism sheet PRM-V regulates or adjust the direction of incident light, up or down, the third highlight region HL3 was displaced in a higher direction relative to the second highlight region HL2.

In the fourth viewing angle graph VAF4, a fourth highlight region HL4, which is the central region in the graph, has the largest data value. Since the horizontal prism sheet PRM-H regulates the orientation of incident light, left or right, the fourth highlight region HL4 is concentrated in the central region to a greater degree than is the third highlight region HL3. The fourth viewing angle graph VAF4 has data values which are more uniform overall, compared to the first to third viewing angle graphs VAF1 to VAF3.

In the fifth viewing angle graph VAF5, a fifth highlight region HL5, which is the central region in the graph, has the largest data value. In the sixth viewing angle graph VAF6, a sixth highlight region HL6, which is in the central region in the graph, has the largest data value. The fifth and sixth highlight regions HL5 and HL6 are substantially identical to the fourth highlight region HL4, which is because light which is transmitted by the prism sheets PRM-V and PRM-H is perpendicularly incident, and thus there is no great change in the direction toward which light is oriented.

Consequently, the direction toward which light that is emitted from the first backlight unit BLU1 is oriented is the forward direction of the display device DD. As described above, since humans view the display device DD from the front of the display device DD, light which is emitted from the first backlight unit BLU1 reaches humans.

FIG. 8B illustrates a viewing angle graph of light which is emitted from the second backlight unit BLU2, in the case in which only the second light LS2 (refer to FIG. 6) is turned on.

Seventh and eighth viewing angle graphs VAF7 and VAF8 are measurements of the intensity of light which was perpendicularly incident on the hemispheric lens which was placed on the second light guide plate LGP2 and the second diffuser DFF2, respectively. For measurement thereof, the measuring instrument known as EZ Contrast from ELDIM was used. A larger data value in the viewing angle graph indicates a greater amount of incident light.

In the seventh viewing angle graph VAF7, a seventh highlight region HL7, which is the lowest edge region, has the largest data value. The seventh viewing angle graph VAF7 has data values which are nearly identical to those of the first viewing angle graph VAF1. Therethrough, it may be known that light which is emitted from the second light guide plate LGP2 is oriented in a direction toward the floor which is lower than the display device DD. Such is because, as illustrated in FIG. 6, the second light source LS2 is disposed on the second top surface SF2-U of the second light guide plate LGP2.

In the eighth viewing angle graph VAF8, an eighth highlight region HL8, which is the lower middle region in the graph, has the largest data value. The eighth viewing angle graph VAF8 has data values which are nearly identical to those of the second viewing angle graph VAF2.

Therethrough, it may be known that light which is transmitted by the second diffuser DFF2 is more diffuse than light which is emitted from the second light guide plate LGP2. Moreover, light which is transmitted by the second diffuser DFF2 is still oriented in a direction toward the floor which is lower than the display device DD.

Consequently, the direction toward which light that is emitted from the second backlight unit BLU2 is oriented is the direction below the display device DD, in embodiments, a direction which is oriented toward the floor. As described above, since dogs view the display device DD from a lower position than the display device DD, light which is emitted from the second backlight unit BLU2 reaches dogs.

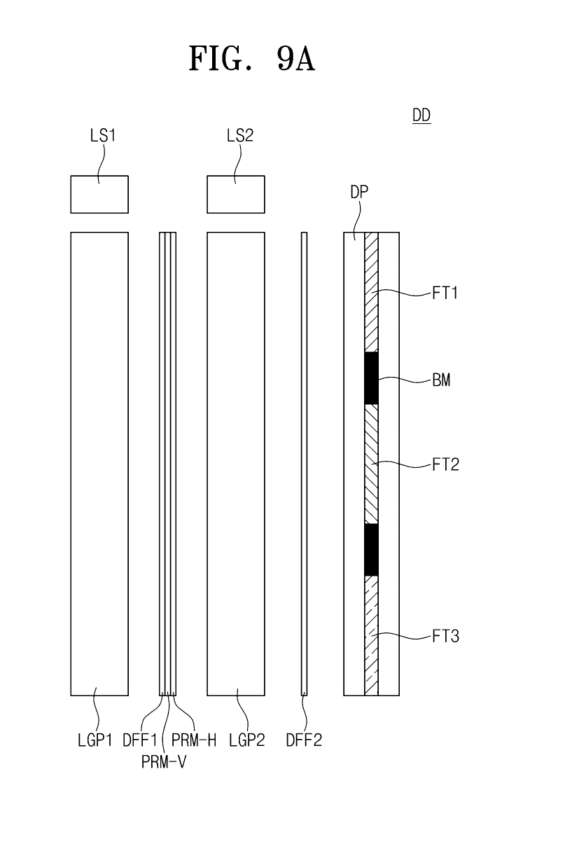

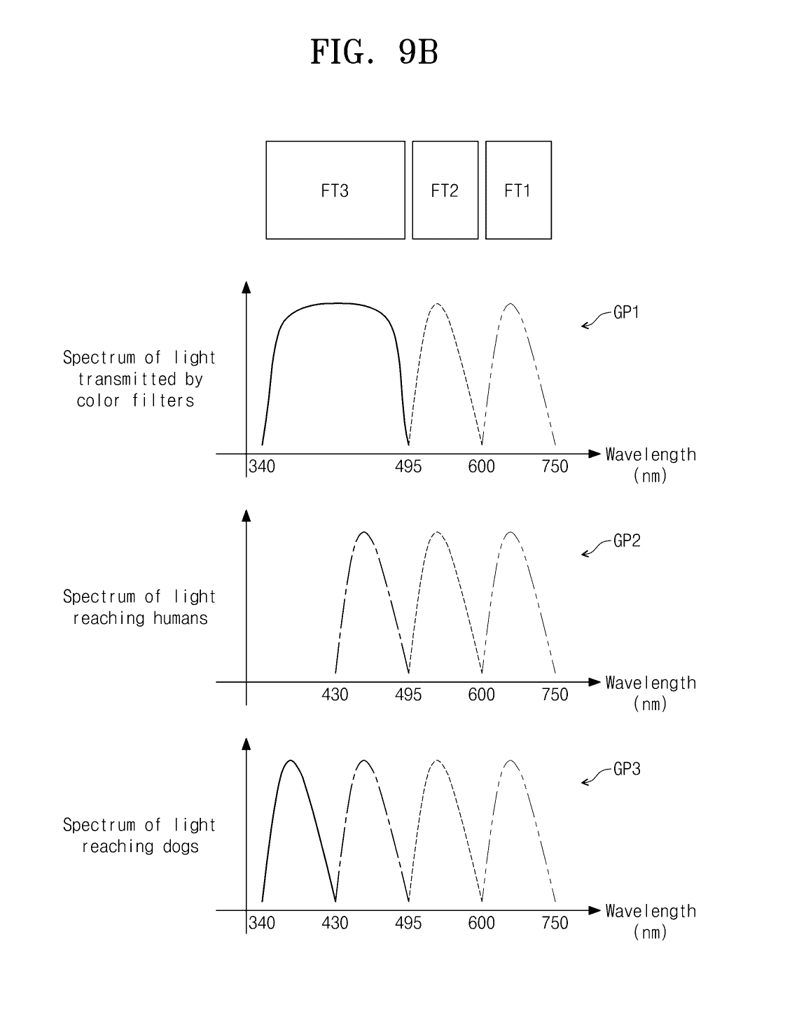

FIG. 9A illustrates a cross-section of a side of the display device DD according to an embodiment of the inventive concept. FIG. 9B illustrates the spectrum of light which is transmitted by color filters of the display panel according to an embodiment of the inventive concept.

The display panel DP includes a first color filter FT1, a second color filter FT2, and a third color filter FT3. Black matrixes BM may be interposed between the color filters FT1, FT2, and FT3 to prevent or inhibit colors from mixing. In embodiments, the display panel DP may have a plurality of pixels and the first, second and third color filters are provided for each pixel. However, the inventive conception is not limited thereto.

A first graph GP1 illustrates the spectrum of light which is transmitted by each of the first to third color filters FT1, FT2, and FT3. The first color filter FT1 may transmit light which has a wavelength of about 600 nm to about 750 nm. The second color filter FT2 may transmit light which has a wavelength of about 495 nm to about 600 nm. The third color filter FT3 may transmit light which has a wavelength of about 340 nm to about 495 nm.

A second graph GP2 illustrates the spectrum of light which reaches humans after being emitted from the first backlight unit BLU1 and transmitted by the first to third color filters FT1, FT2, and FT3. The first light source LS1 of the first backlight unit BLU1 may emit light which has a wavelength of about 430 nm to about 780 nm.

The first color filter FT1 may transmit the light, among that which is emitted from the first backlight unit BLU1, which has a wavelength of about 600 nm to about 750 nm. Light which is transmitted by the first color filter FT1 is recognized as being red to the eyes of humans.

The second color filter FT2 may transmit the light, among that which is emitted from the first backlight unit BLU1, which has a wavelength of about 495 nm to about 600 nm. Light which is transmitted by the second color filter FT2 is recognized as being green to the eyes of humans.

The third color filter FT3 may transmit the light, among that which is emitted from the first backlight unit BLU1, which has a wavelength of about 430 nm to about 495 nm. Light which is transmitted by the third color filter FT3 is recognized as being blue to the eyes of humans. Although the wavelength of light which the third color filter FT3 is capable of transmitting is about 340 nm to about 495 nm, since the first backlight unit BLU1 does not emit light which has a wavelength below about 430 nm, light which is sensed by humans after being transmitted by the third color filter, has a wavelength of about 430 nm to about 495 nm.

Light which is emitted from the second backlight unit BLU2 is oriented toward the floor, and thus hardly sensed by the humans who are positioned in front of the display device DD. Therefore, the wavelength of light which is sensed by humans is about 430 nm to about 750 nm, as illustrated in the second graph GP2.

A third graph GP3 illustrates the spectrum of light which reaches dogs after being emitted from the first and second backlight units BLU1 and BLU2, and transmitted by the first to third color filters FT1, FT2, and FT3. The second light source LS2 of the second backlight unit BLU2 may emit at least light which has a wavelength of about 340 nm to about 430 nm, and the first light source LS1 of the first backlight unit BLU1 may emit light which has a wavelength of about 430 nm to about 780 nm.

Description of the first color filter FT1 and second color filter FT2 may be identical to the description given for the second graph GP2, and thus will not be given.

The third color filter FT3 may transmit the light, among that which is emitted from the first and second backlight units BLU1 and BLU2, which has a wavelength of about 340 nm to about 430 nm. Light which has a wavelength of about 340 nm to about 430 nm is not easily sensed by humans, but may be sensitively sensed by dogs.

As such, when the display panel DP includes the first to third color filters FT1, FT2, and FT3, the display device DD which may be used together by humans and dogs may be provided.

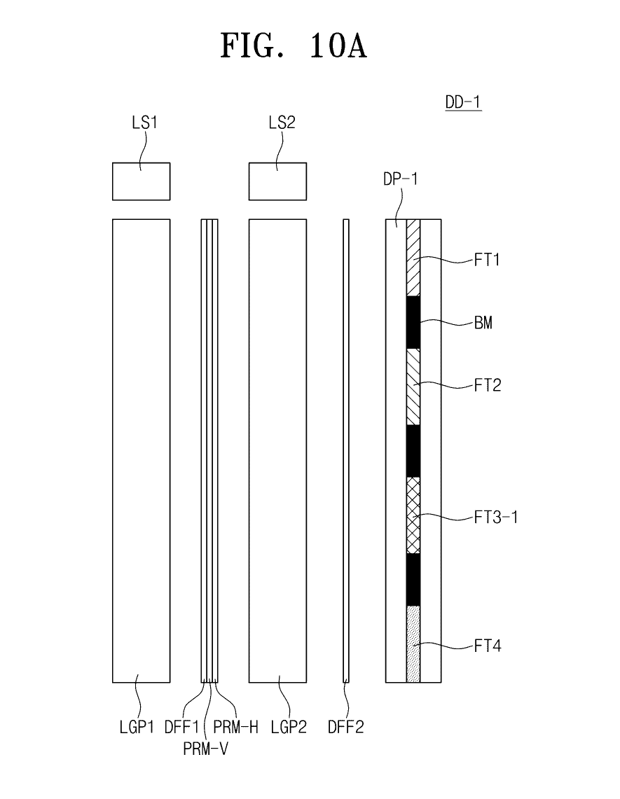

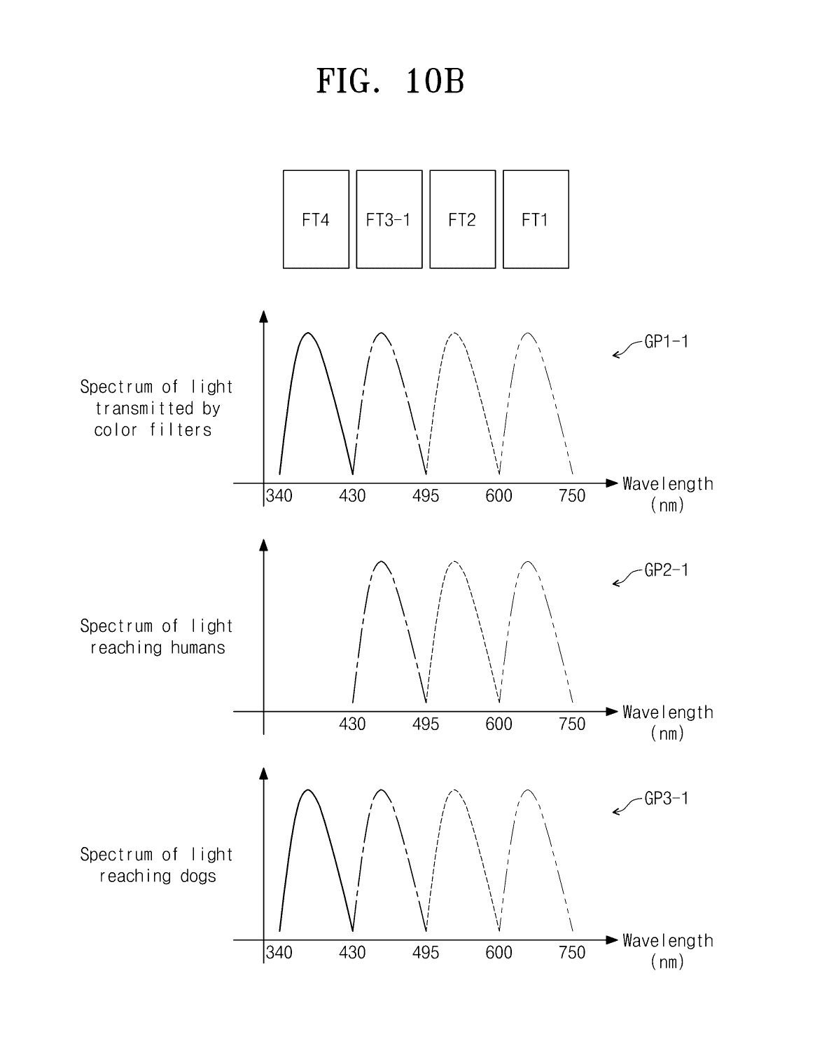

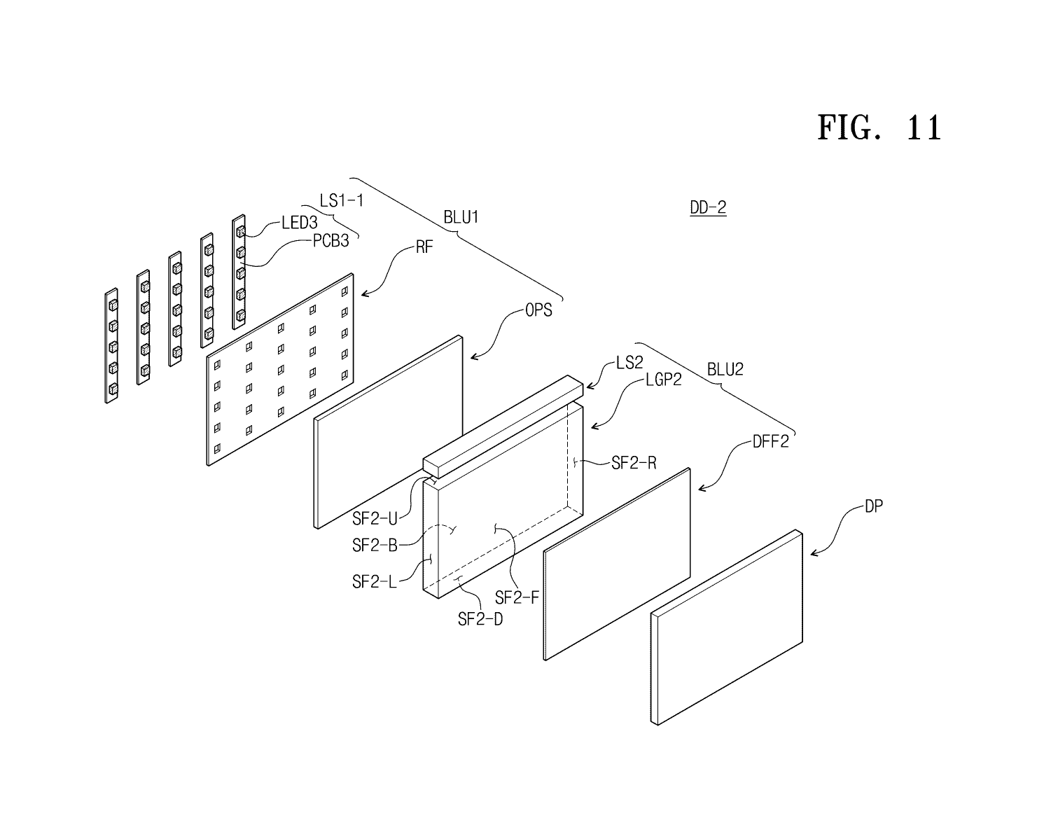

FIG. 10A illustrates a cross-section of a side of a display device DD-1 according to an embodiment of the inventive concept. FIG. 10B illustrates the spectrum of light which is transmitted by the color filters of a display panel according to an embodiment of the inventive concept.

The display panel DP-1 includes the first color filter FT1, the second color filter FT2, a third color filter FT3-1 and a fourth color filter FT4. Black matrixes BM may be interposed between the color filters FT1, FT2, FT3-1, and FT4 to prevent mixing of colors. In embodiments, the display panel DP may have a plurality of pixels; and the first, second, third and fourth color filters are provided for each pixel. However, the inventive conception is not limited thereto.

A first graph GP1-1 illustrates the spectrum of light which is transmitted by each of the first to fourth color filters FT1, FT2, FT3-1, and FT4. Description of the first color filter FT1 and second color filter FT2 may be identical to description given in FIGS. 9A and 9B, and thus will not be given.

The third color filter FT3-1 may transmit light which has a wavelength of about 430 nm to about 495 nm. The fourth color filter FT4 may transmit light which has a wavelength of about 340 nm to about 430 nm.

A second graph GP2-1 illustrates the spectrum of light which reaches humans after being emitted from the first backlight unit BLU1, and transmitted by the first to fourth color filters FT1, FT2, FT3-1, and FT4. The first light source LS1 of the first backlight unit BLU1 may emit light which has a wavelength of about 430 nm to about 780 nm.

Description of the light which is transmitted by the first color filter FT1 and light which is transmitted by the second color filter FT2 may be identical to description given in FIGS. 9A and 9B, and thus will not be given.

The third color filter FT3-1 may transmit the light, among that which is emitted from the first backlight unit BLU1, which has a wavelength of about 430 nm to about 495 nm. Light which is transmitted by the third color filter FT3-1 is recognized as being blue to the eyes of humans.

Light which is emitted from the second backlight unit BLU2 is oriented toward the floor, and thus hardly sensed by the humans who are positioned in front of the display device DD. Therefore, the wavelength of light which is sensed by humans is about 430 nm to about 750 nm, as illustrated in the second graph GP2.

A third graph GP3-1 illustrates the spectrum of light which reaches dogs after being emitted from the first and second backlight units BLU1 and BLU2, and transmitted by the first to fourth color filters FT1, FT2, FT3-1, and FT4. Description of the wavelength of light which is emitted from the first light source LS1 of the first backlight unit BLU1 and the second light source LS2 of the second backlight unit BLU2 may be identical to description given in FIGS. 9A and 9B, and thus will not be given. Moreover, description of the first color filter FT1 and second color filter FT2 may be identical to description given in FIGS. 9A and 9B, and thus will not be given.

The third color filter FT3-1 may transmit the light, among that which is emitted from the first and second backlight units BLU1 and BLU2, which has a wavelength of about 430 nm to about 495 nm.

The fourth color filter FT4 may transmit the light, among that which is emitted from the first and second backlight units BLU1 and BLU2, which has a wavelength of about 340 nm to about 430 nm. Light which has a wavelength of about 340 nm to about 430 nm is light which is not easily sensed by humans, but which may be sensitively sensed by dogs.

As such, when the display panel DP includes the first to fourth color filters FT1, FT2, FT3-1, and FT4, the display device DD-1 which may be used together by humans and dogs may be provided.

FIG. 11 is an exploded perspective view of a display device according to an embodiment of the inventive concept. The display device DD-2 includes a first backlight unit BLU1-1, the second backlight unit BLU2, and the display panel DP.

Description of the second backlight unit BLU2 and the display panel DP may be identical to description given in FIG. 6, and thus will not be given.

The first backlight unit BLU1-1 includes a first light source LS1-1 and an optical member OPS.

The first backlight unit BLU1-1 includes a plurality of third light emitting diode packages LED3 and a third printed circuit board PCB3. The third light emitting diode packages LED3 are mounted on the third printed circuit board PCB3. The first light source LS1-1 emits light which is in the visible light region of about 430 nm to about 780 nm.

The optical member OPS improves the properties of light which is received from light source blocks LSB and then provides the light to the display panel DP. The optical member OPS includes at least a diffusion member. The diffusion member uniformly diffuses incident light. The optical member OPS may further include a light collecting sheet which collects light that is received from the diffusion member. Moreover, the optical member OPS may further include the diffusion member and/or a protective sheet which protects the collecting sheet.

The first backlight unit BLU1-1 may further include a reflective layer RF which reflects light, which is emitted from the third light emitting diode packages LED3, toward the display panel DP.

Unlike in the first backlight unit BLU1 illustrated in FIG. 6, in the first backlight unit BLU1-1 illustrated in FIG. 11, the first light source LS1-1 provides light directly to the display panel DP. Classifying such backlight units, the first backlight unit BLU1 illustrated in FIG. 6 is known as an edge type, and the first backlight unit BLU1-1 illustrated in FIG. 11 is known as a direct type.

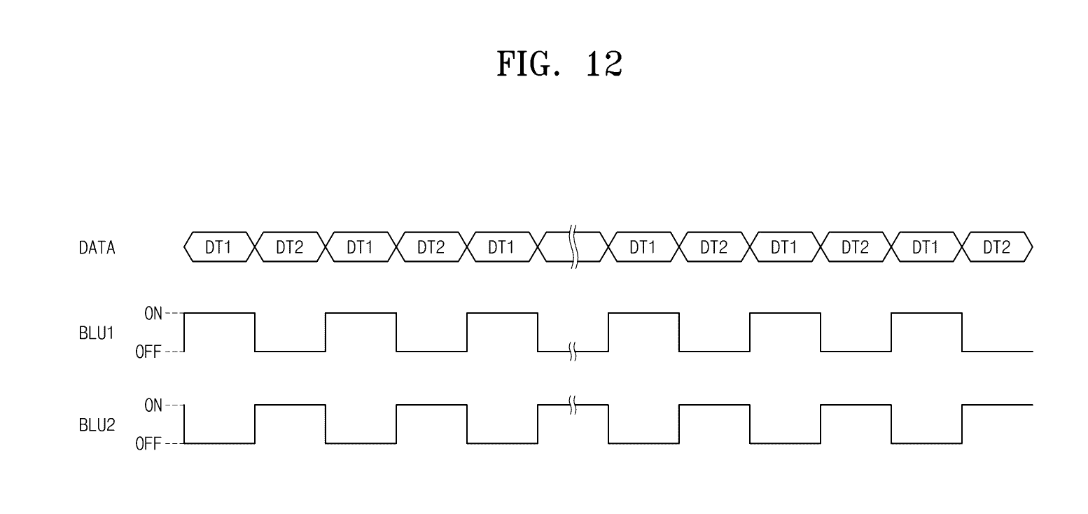

FIG. 12 illustrates the drive timing of the first backlight unit and the second backlight unit according to an embodiment of the inventive concept.

Referring to FIG. 12, data signals DS1 and DS2, which are applied to the display panel DP, are classified as first data signals DS1 and second data signals DS2.

The first data signals DS1 are signals which contain data that is to be provided for humans. Conversely, the second data signals DS2 are signals which contain data that is to be provided for dogs. The first data signals DS1 and the second data signals DS2 are alternatingly applied to the display panel DP.

The first backlight unit BLU1 is turned on in synchronization with the timing of the application of the first data signals DS1 to the display panel DP, and turned off in synchronization with the timing of the application of the second data signals DS2 to the display panel DP.

The second backlight unit BLU2 is turned on in synchronization with the timing of the application of the second data signals DS2 to the display panel DP, and turned off in synchronization with the timing of the application of the first data signals DS1 to the display panel DP.

As such, when the drive timing of the first and second backlight units BLU1 and BLU2 is synchronized with the timing of the application of the first and second data signals DS1 and DS2 to the display panel DP, even though humans and dogs are viewing the display device DD at the same time, the image data which are received by humans and dogs differ from each other.

A display device according to an embodiment of the inventive concept may display images which have a spectrum corresponding to the characteristics of human vision, and a spectrum corresponding to the characteristics of the vision of animals other than humans. Consequently, both humans and animals other than humans may sense images which are identical to real-life images, through the display device.

While embodiments of the inventive concept have been described with reference to the accompanying drawings, it will be understood by those skilled in the art that the inventive concept may be embodied in other specific forms without changing the technical scope or essential features thereof. Therefore, the embodiments set forth herein shall be understood in every way as being merely examples, and thus not limiting.

What is claimed is:

1. A display device comprising:
a display panel;
a first backlight unit configured to provide first light beams toward the display panel, the first light beams having wavelengths in a first wavelength range; and
a second backlight unit disposed between the display panel and the first backlight unit, and configured to provide second light beams toward the display panel, the second light beams having wavelengths in a second wavelength range different from the first wavelength range,
wherein the second backlight unit comprises:
a front light guide plate comprising a front surface, a rear surface, a top surface, a bottom surface, a left surface and a right surface; and
a short-wavelength light source configured to emit light which has a wavelength of about 340 nm to about 430 nm toward the top surface of the front light guide plate.

2. The display device of claim 1, wherein the second backlight unit further comprises a front diffuser which is disposed between the front light guide plate and the display panel and configured to diffuse the light which is guided by the front light guide plate such that the second backlight unit provides the second light beams toward the display panel.

3. The display device of claim 2, wherein the first light beams are configured to travel in a first traveling direction which is generally perpendicular to the display surface, and the second beams are configured to travel in a second traveling direction which is different from the first traveling direction.

4. The display device of claim 3, wherein, when the display device is placed over a floor such that a display surface of the display panel is generally perpendicular to the floor, the second light beams are configured to travel in the second traveling direction toward the floor.

5. The display device of claim 4, wherein the first traveling direction of the first light beams and the second traveling direction of the second light beams form a predetermined acute angle therebetween.

6. The display device of claim 2, wherein the first backlight unit comprises:
a long-wavelength light source configured to emit light which has a wavelength of about 430 nm to about 780 nm;
a rear light guide plate configured to guide the light, which is emitted from the long-wavelength light source, toward the display panel;
a rear diffuser configured to diffuse the light which is guided by the rear light guide plate; and
a prism sheet configured to adjust traveling directions of the diffused light such that the first backlight unit provides the first light beams traveling in a direction generally perpendicular to a display surface of the display panel.

7. The display device of claim 6, wherein the prism sheet comprises:
a vertical prism sheet configured to adjust the traveling direction of the diffused light in a vertical plane; and
a horizontal prism sheet configured to adjust the traveling direction of the diffused light in a horizontal plane,
wherein the vertical prism is located between the rear diffuser and the horizontal prism sheet.

8. The display device of claim 6, wherein the prism sheet comprises:
a horizontal prism sheet configured to adjust the traveling direction of the diffused light in a horizontal plane; and
a vertical prism sheet configured to adjust the traveling direction of the diffused light in a vertical plane,
wherein the horizontal prism is located between the rear diffuser and the vertical prism sheet.

9. The display device of claim 2, wherein the first backlight unit comprises:
a long-wavelength light source configured to emit light which has a wavelength of about 430 nm to about 780 nm; and
a reflective layer configured to reflect the light, which is emitted from the long-wavelength light source, toward the display panel.

10. The display device of claim 2, wherein the display panel comprises:
a first color filter capable of transmitting light which has a wavelength of about 600 nm to about 750 nm;
a second color filter capable of transmitting light which has a wavelength of about 495 nm to about 600 nm; and
a third color filter capable of transmitting light which has a wavelength of about 340 nm to about 495 nm.

11. The display device of claim 2, wherein the display panel comprises:
a first color filter capable of transmitting light which has a wavelength of about 600 nm to about 750 nm;
a second color filter capable of transmitting light which has a wavelength of about 495 nm to about 600 nm;
a third color filter capable of transmitting light which has a wavelength of about 430 nm to about 495 nm; and
a fourth color filter capable of transmitting light which has a wavelength of about 340 nm to about 430 nm.

12. The display device of claim 2, wherein:
the display panel is configured to receive first data signals and second data signals, the second data signals alternate with the first data signals;
the first backlight unit is configured to be turned on or off in synchronization with the first data signals; and
the second backlight unit is configured to be turned on or off in synchronization with the second data signals.

13. A display device comprising:
a display panel comprising a display surface and configured to display an image on the display surface, wherein the display panel is configured to be placed over a floor such that the display surface is generally perpendicular to the floor;
a first backlight unit configured to provide first light beams, which travel through the display panel in a first direction generally perpendicular to the display surface; and
a second backlight unit disposed between the display panel and the first backlight unit, and configured to provide second light beams, which travel toward the floor through the display panel in a second direction which forms a predetermined acute angle with respect to the first direction,
wherein at least part of the second light beams have a wavelength of at least about 340 nm to about 430 nm.

14. The display device of claim 13, wherein the first light beams have a wavelength of about 380 nm to about 780 nm.

15. The display device of claim 14, wherein the first backlight unit comprises:
a first light source;
a first light guide plate configured to guide light, which is emitted from the first light source, toward the display panel;
a first diffuser configured to diffuse light which is guided by the first light guide plate; and
a prism sheet configured to adjust traveling directions of the diffused light such that the first backlight unit provides the first light beams traveling in a direction generally perpendicular to a display surface of the display panel.

16. The display device of claim 14, wherein the first backlight unit comprises:
a first light source configured to emit light; and
a reflective layer configured to reflect the light, which is emitted from the first light source, toward the display panel.

17. The display device of claim 13, wherein the second backlight unit comprises:
a second light guide plate configured to guide incident light toward the display panel;
a second light source configured to emit light having a wavelength of at least about 340 nm to about 430 nm to the second light guide plate, and is disposed over a top surface of the second light guide plate; and
a second diffuser configured to diffuse the light which is guided by the second light guide plate.

18. The display device of claim 13, wherein the display panel comprises:
a first color filter capable of transmitting light which has a wavelength of about 600 nm to about 750 nm;
a second color filter capable of transmitting light which has a wavelength of about 495 nm to about 600 nm; and
a third color filter capable of transmitting light which has a wavelength of about 340 nm to about 495 nm.

19. The display device of claim 13, wherein the display panel comprises:
a first color filter capable of transmitting light which has a wavelength of about 600 nm to about 750 nm;
a second color filter capable of transmitting light which has a wavelength of about 495 nm to about 600 nm;
a third color filter capable of transmitting light which has a wavelength of about 430 nm to about 495 nm; and
a fourth color filter capable of transmitting light which has a wavelength of about 340 nm to about 430 nm.

20. The display device of claim 13, wherein:
the display panel is configured to receive first data signals and second data signals, the second data signals alternate with the first data signals;
the first backlight unit is configured to be turned on or off in synchronization with the first data signals; and
the second backlight unit is configured to be turned on or off in synchronization with the second data signals.
